(19) United States
(12) Patent Application Publication
(10) Pub. No.: US 2021/0116966 A1
(43) Pub. Date: Apr. 22, 2021

(54) DISPLAY MODULES FOR COMPUTING DEVICES

(71) Applicant: Hewlett-Packard Development Company, L.P., Spring, TX (US)

(72) Inventors: Alexander Wayne Clark, Spring, TX (US); Rahul V. Lakdawala, Spring, TX (US); Chao-Chiang Lin, Taipei City (TW)

(73) Assignee: Hewlett-Packard Development Company, L.P., Spring, TX (US)

(21) Appl. No.: 16/977,926

(22) PCT Filed: May 2, 2018
(86) PCT No.: PCT/US2018/030683

§ 371 Date: Sep. 3, 2020

(51) Int. Cl. G06F 1/16

(52) U.S. Cl. CPC G06F 1/1649

(57) ABSTRACT

In an example implementation according to aspects of the present disclosure, a method may include determining which edge of a computing device a display module is to attach to, determining an orientation of the display module with respect to the edge the display module is to attach to, and adjusting a display setting on the display module based on the orientation and the edge the display module is to attach to.

### BACKGROUND

The emergence and popularity of mobile computing has made portable computing devices, due to their compact design and light weight, a staple in today's marketplace. Within the mobile computing realm, notebook computers, or laptops, are one of the most widely used devices and generally employ a clamshell-type design having two members connected together at a common end via hinges, for example. In some cases, a first or display member is utilized to provide a viewable display to a user while a second or base member includes an area for user input (e.g., touchpad and keyboard). In addition, the viewable display may be a touchscreen (e.g., touchscreen laptop), allowing the user to interact directly with what is displayed by touching the screen with simple or multi-touch gestures.

### BRIEF DESCRIPTION OF THE DRAWINGS

FIGS. 1A-C illustrate a system including a computing device and a display module that can be attached to edges of the computing device in varying orientations, according to an example;

FIG. 2 illustrates a block diagram of an edge of the display module as it is being attached to an edge of the computing device, according to an example;

FIG. 3 illustrates a computing device for outputting viewable data to display modules attached, according to an example; and

FIG. 4 is a flow diagram in accordance with an example of the present disclosure.

### DETAILED DESCRIPTION

As the processing resources of computing devices, such as notebook computers, continue to increase, users are provided the opportunity to handle multiple tasks at the same time on a notebook computer. As a result, besides relying solely on the display member of the notebook computer, users may prefer to utilize multiple displays, in addition to the display member of the notebook computer, while performing the tasks on the notebook computer.

Examples disclosed herein provide the ability to dynamically attach display modules to edges of the base member or display member of computing devices, such as notebook computers, in order to expand the viewable area for users while multitasking on the computing device. As will be further described, as users attach a display module to an edge of the base member or display member, and the orientation in which they attach the display module, display settings on the display module are automatically adjusted so users can have access to additional display space while performing tasks on the computing device, all without much effort.

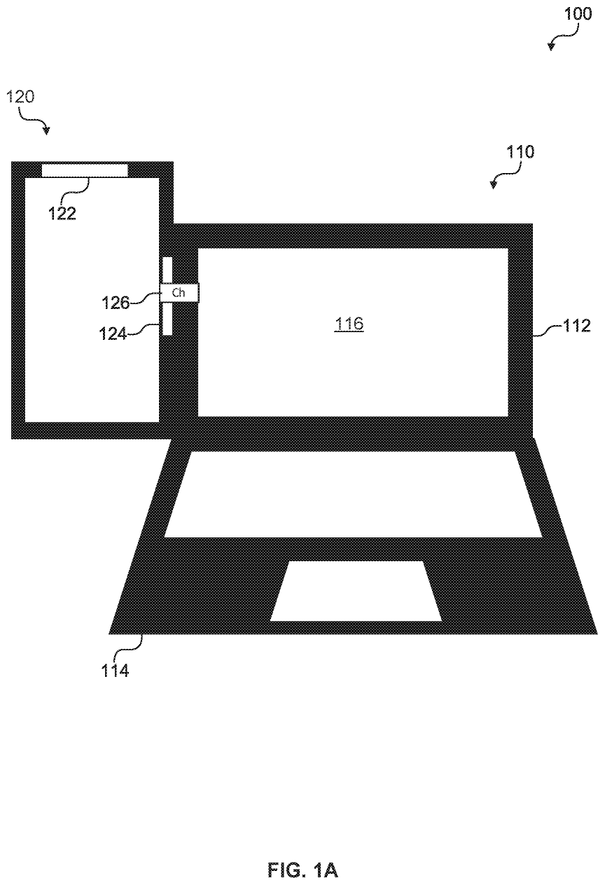

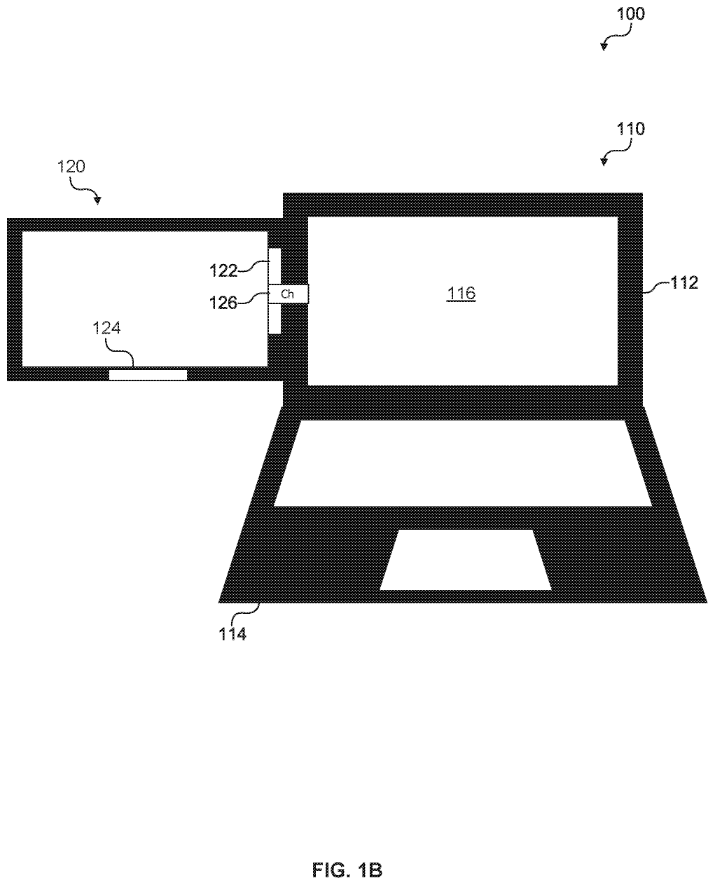

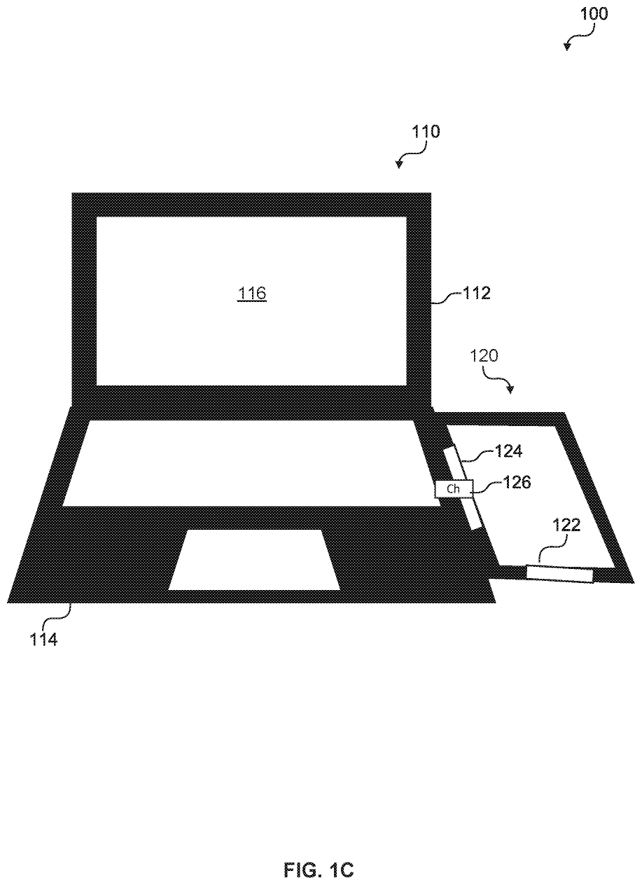

With reference to the figures, FIGS. 1A-C illustrate a system 100 including a computing device 110 and a display module 120 that can be attached to edges of the computing device 110 in varying orientations, according to an example. The computing device 110 includes a display member 112 and a base member 114 that are rotatably connected to each other. As an example, the base member 114 includes a top surface that may include input means for operation by a user, such as a keyboard and/or a touchpad as illustrated. The display member 112 includes a display surface 116 that may be used for viewing the video output of the computing device 110, and include input means for operation by a user, such as a touchscreen. As mentioned above, the display module 120 expands the viewable area for users while multitasking on the computing device 110, in addition to the display surface 116.

As illustrated in FIGS. 1A-C, the display module 120 may be attached to various edges of the display member 112 or base member 114 of the computing device 110, and in varying orientations, providing a level of modularity that may be desirable for users. For example, referring to FIG. 1A, the display module 120 may be attached to the left edge of the display member 112 in a portrait orientation. However, referring to FIG. 1B, the display module 120 may be attached to the same edge of the display member 112, but in a landscape orientation. As will be further described, once the orientation of the display module 120 is determined, display settings may be adjusted on the display module 120 in order for viewable data to be outputted appropriately to the display module 120. Lastly, referring to FIG. 10, the display module 120 may also be attached to other edges, such as an edge of the base member 114, in varying orientations (e.g., portrait, as illustrated). As a result, in addition to determining the orientation of the display module 120 as it is attached to the computing device 110, the edge that the display module 120 is attached to may also be determined. Therefore, the viewable data that is output to the display module 120 may vary, based on the edge that it is attached to. For example, if the display module 120 is attached to a left edge of the computing device 110 (either the display member 112 or base member 114), the viewable data transmitted to the display module may be an extension to the left of the desktop illustrated on the display surface 116. Similarly, if the display module 120 is attached to a right edge of the computing device 110, the viewable data transmitted to the display module may be an extension to the right of the desktop illustrated on the display surface 116. Although the display module 120 may be attached to the left or right edge of the display member 112, or the left or right edge of the base member 114, the number of edges available on the computing device 110 that the display module 120 can attach to may vary.

As will be further described, various electrical components from the computing device 110 and display module 120 are used to determine the placement of the display module 120 with respect to an edge of the computing device 110, to power the display module 120, and to transmit the viewable data to the display module 120 according to the determinations made. As an example, electrical components associated with the display module 120 may be generally represented by elements 122, 124, but will be described further herein. As an example, the elements 122, 124 may also include magnetic members, for example, to magnetically couple with magnetic members along the edge of the computing device 110 the display module 120 attaches to. As a result, the magnetic members allow the display module 120 to snap into place, and holds the display module 120 affixed in position, until an opposing force greater than the magnetic attraction is applied to detach the display module 120 from the computing device 110.

Electrical components may be found along each edge of the computing device (e.g., the left and right edges of the display member 112, and the left and right edges of the base member 114) to interact with either element 122 or element 124 of the display module 120. As an example, the element of the display module 120 (element 122 or element 124) that interacts with electrical components on the edge that the display module 120 is attached may be used for determining whether the display module 120 is attached in a portrait or landscape orientation. For example, referring to FIG. 1A, as element 124 interacts with electrical components on the left edge of the display member 112, it may be determined that the display module is in a portrait orientation. Similarly, referring to FIG. 1B, as element 122 interacts with electrical components on the left edge of the display member 112, it may be determined that the display module is in a landscape orientation. Once placement of the display module 120 with respect to an edge of the computing device 110 is determined, a port along the edge may be activated to power the display module 120, and a channel 126 may be established between the computing device 110 and display module 120, for viewable data to be transmitted to the display module 120. Although two elements are provided on edges of the display module 120 (elements 122, 124), additional elements may be provided, for example, on the remaining two edges of the display module 120, However, the two elements illustrated may be sufficient, for cost-saving reasons as an example. For example, if the display module 120 is moved from the position illustrated in FIG. 1A to the position illustrated in FIG. 10, the display module 120 may be rotated by 180 degrees in order to attach to the right edge of the base member 114.

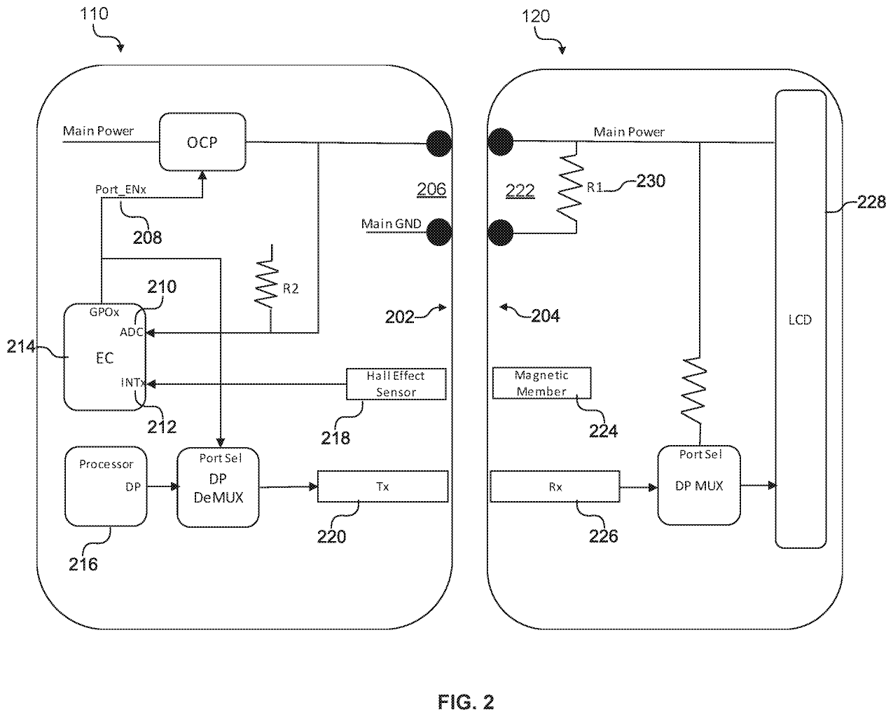

FIG. 2 illustrates a block diagram of an edge 204 of the display module 120 as it is being attached to an edge 202 of the computing device 110, according to an example. Referring back to FIGS. 1A-C, edge 204 of the display module 120 may correspond to edges containing element 122 or element 124, and edge 202 of the computing device 110 may correspond to the left or right edge of the display member 112, or the left or right edge of the base member 114. As illustrated, electrical contacts 222 of the display module 120 come in contact with electrical contacts 206 of the computing device 110. As an example, the electrical contacts may refer to pogo pins. In addition to the electrical contacts coming in contact with each other, a magnetic member 224 from the edge of the display module 120 activates a Hall Effect sensor 218 along the edge of computing device 110 the display module 120 attaches to. As a result, each edge of the computing device 110 may have its own distinct Hall Effect sensor, which may be used for determining which edge of the base member 114 or display member 112 the display module 120 is to attach to. For example, the embedded controller (EC) 214 may receive an interrupt signal (INTx) 212 from the distinct Hall Effect sensor along edge of the base member 114 or display member 112 that is activated by magnetic member 224. For example, the Hall Effect sensor along the left edge of the display member 112 may correspond to INT1, the Hall Effect sensor along the right edge of the display member 112 may correspond to INT2, the Hall Effect sensor along the left edge of the base member 114 may correspond to INT3, and the Hall Effect sensor along the right edge of the base member 114 may correspond to INT4.

Upon determining the edge of the computing device 110 the display module 120 is attached to, the EC 214 may determine the orientation of the display module 120 with respect to the edge the display module 120 is to attach to. As an example, the processor 216 may read an analog-to-digital conversion (ADC) value 210 generated at the EC 214. As an example, if ADC is able to operate in 3.3 V, and the processor 216 reads an ADC value 210 of 3.3 V at the EC 214, the processor 216 would determine that no display module 120 is attached to the computing device 110. However, if the ADC value 210 equals a first preset value, the processor 216 may determine that display module 120 is attached in a portrait orientation. Similarly, if the ADC value 210 equals a second preset value different from the first present value, the processor 216 may determine that display module 120 is attached in a landscape orientation. As an example, different values resistor R1 230, placed in between the power and ground connections 222 may provide different ADC levels between the power and ground connections 206 at the computing device 110. Referring back to FIG. 1A-C, the resistor R1 found in element 122 may be a different value from the resistor R1 found in element 124. As a result, different ADC values 210 are generated at the EC 214, based on whether the display module 120 is attached in a portrait or landscape orientation. As an example, if a ADC value 210 read by the processor 216 is a third preset value different from the first and second preset values, the processor 216 may determine that a peripheral in place of the display module 120 is attached to the edge (e.g., pico-projector). Finally, if the ADC value generated does not equal 3.3 V, or the first, second, or third preset value, the processor 216 may determine that an invalid module is attached, or the display module 120 is attached in an orientation that is not supported by the computing device 110.

Upon determining the edge of the base member 114 or display member 112 the display module 120 is to attach to, the processor 216 may enable a port along the edge to power the display module 120. Referring to FIG. 2, the port may correspond to the electrical contacts 206. In order to ensure that the correct port is enabled, as each edge along the computing device 110 may have their own port, Port_ENx 208 may be set by the EC 214, according to the distinct Hall Effect sensor 218 activated, as described above. For example, if the EC 214 receives interrupt signal INT1, which corresponds to the distinct Hall Effect sensor along the left edge of the display member 112, Port_EN1 may be set by the EC 214 to enable to electrical contacts along the left edge of the display member 112 for powering the display module 120.

In addition to the computing device 110 powering the display module 120, a channel may be established for outputting viewable data to the display module 120. For example, the viewable data may be transmitted by a transmitter (Tx) 220 of the computing device 110, and received by a receiver (Rx) 226 of the display module 120 and output, for example, via LCD 228. The display settings of the viewable data output by the processor 216 may be dependent upon the placement of the display module 120 with respect to the computing device 110, and its orientation. For example, if the display module 120 is attached to a left edge of the computing device 110 (either the display member 112 or base member 114), the viewable data transmitted to the display module 120 may be an extension to the left of the desktop illustrated on the display surface 116. Similarly, if the display module 120 is attached to a right edge of the computing device 110, the viewable data transmitted to the display module 120 may be an extension to the right of the desktop illustrated on the display surface 116. In addition, the orientation of the display module 120, as detected by the EC 214, may control how the display settings of the viewable data is output by the processor 216 (e.g., whether the viewable data should be output in a portrait or landscape orientation). However, the orientation of the viewable data may be controlled at the display module 120 itself. For example, if a particular Hall Effect sensor is placed on at least one edge of the display module (e.g., element 122 or element 124), activation of the Hall Effect sensor will provide an indication that the edge containing the Hall Effect sensor is attached to an edge of the computing device 110. However, if the Hall Effect sensor remains inactivated, the other edge is likely attached to the edge of the computing device 110. As a result, instructions that control operations of display module 120 (e.g., firmware) on the display module 120 may change the orientation of the viewable data received, according to the detected orientation of the display module 120 with respect to the edge of the computing device 110.

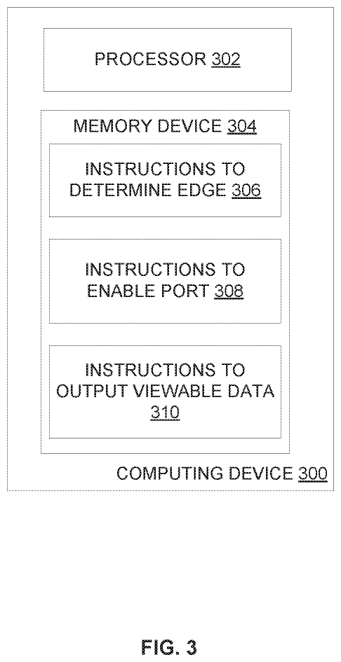

FIG. 3 illustrates a computing device 300 for outputting viewable data to display modules attached, according to an example. Examples of the computing device include, but are not limited to, notebook computers. The computing device 300 depicts a processor 302 and a memory device 304 and, as an example of the computing device 300 performing its operations, the memory device 304 may include instructions 306-310 that are executable by the processor 302. Thus, memory device 304 can be said to store program instructions that, when executed by processor 302, implement the components of the computing device 300. As an example, the processor 302 corresponds to processor 216 illustrated in FIG. 2. The executable program instructions stored in the memory device 304 include, as an example, instructions to determine edge (306), instructions to enable port (308), and instructions to output viewable data (310).

Instructions to determine edge (306) represent program instructions that when executed by the processor 302 cause the computing device 300 to determine which edge of the computing device the display module is to attach to. As described above, each edge of the computing device includes a distinct Hall Effect sensor that may be used for determining which edge of the computing device 300 the display module is to attach to. Instructions to enable port (308) represent program instructions that when executed by the processor 302 cause the computing device 300, upon determining the edge of the computing device the display module is to attach to, to enable a port along the edge to power the display module. As each edge along the computing device 300 may have their own port, detecting the edge the display module is to attach to ensures that the correct port is enabled.

Instructions to output viewable data (310) represent program instructions that when executed by the processor 302 cause the computing device 300 to output viewable data to the display module, wherein the viewable data is based on the edge the display module is to attach to. As described above, a channel may be established between the display module and the edge of the computing device 300 the display module attaches to. Display settings of the viewable data may be adjusted, according to the placement of the display module and its orientation. For example, if the display module is attached to a left edge of the computing device 300, the viewable data transmitted to the display module may be an extension to the left of the desktop illustrated on the native display of the computing device 300. Similarly, if the display module is attached to a right edge of the computing device 300, the viewable data transmitted to the display module may be an extension to the right of the desktop illustrated on the native display of the computing device 300. In addition, the orientation of the display module may control how the display settings of the viewable data is output (e.g., whether the viewable data should be output in a portrait or landscape orientation), as described above.

Memory device 304 represents generally any number of memory components capable of storing instructions that can be executed by processor 302. Memory device 304 is non-transitory in the sense that it does not encompass a transitory signal but instead is made up of at least one memory component configured to store the relevant instructions. As a result, the memory device 304 may be a non-transitory computer-readable storage medium. Memory device 304 may be implemented in a single device or distributed across devices. Likewise, processor 302 represents any number of processors capable of executing instructions stored by memory device 304. Processor 302 may be integrated in a single device or distributed across devices. Further, memory device 304 may be fully or partially integrated in the same device as processor 302, or it may be separate but accessible to that device and processor 302.

In one example, the program instructions 306-310 can be part of an installation package that when installed can be executed by processor 302 to implement the components of the computing device 300. In this case, memory device 304 may be a portable medium such as a CD, DVD, or flash drive or a memory maintained by a server from which the installation package can be downloaded and installed. In another example, the program instructions may be part of an application or applications already installed. Here, memory device 304 can include integrated memory such as a hard drive, solid state drive, or the like.

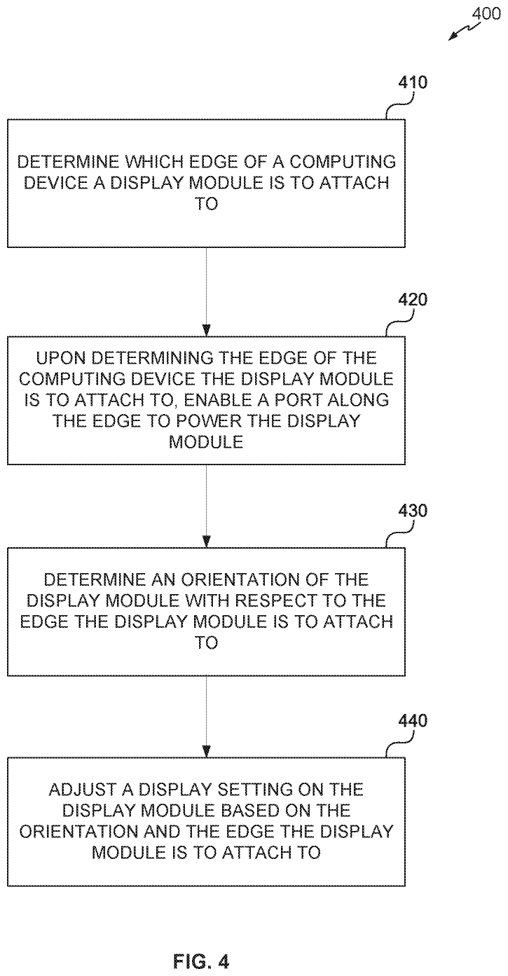

FIG. 4 is a flow diagram 400 of steps taken by a computing device to implement a method for dynamically attaching display modules to edges of the computing device, in order to expand the viewable area for users, according to an example. Although the flow diagram of FIG. 4 shows a specific order of execution, the order of execution may differ from that which is depicted. For example, the order of execution of two or more blocks or arrows may be scrambled relative to the order shown. Also, two or more blocks shown in succession may be executed concurrently or with partial concurrence. All such variations are within the scope of the present invention.

At 410, the computing device determines which edge of the computing device the display module is to attach to. As described above, each edge of the computing device includes a distinct Hall Effect sensor that may be used for determining which edge of the computing device the display module is to attach to. At 420, upon determining the edge of the computing device the display module is to attach to, the computing device enables a port along the edge to power the display module. As each edge along the computing device may have their own port, detecting the edge the display module is to attach to ensures that the correct port is enabled.

At 430, the computing device determines an orientation of the display module with respect to the edge the display module is to attach to. As described above, each edge of the display module may include different resistor values that are placed in between the connections of the port of the computing device (e.g., between the power and ground connections on the edge of the computing device the display module is to attach to). The ADC value generated enables the computing device to determine the orientation of the display module, as described above. At 440, the computing device adjusts a display setting on the display module based on the orientation and the edge the display module is to attach to. For example, the orientation of the viewable data output by the computing device may correspond to the orientation of the display module (e.g., whether displayed in a portrait or landscape orientation)

It is appreciated that examples described may include various components and features. It is also appreciated that numerous specific details are set forth to provide a thorough understanding of the examples. However, it is appreciated that the examples may be practiced without limitations to these specific details. In other instances, well known methods and structures may not be described in detail to avoid unnecessarily obscuring the description of the examples. Also, the examples may be used in combination with each other.

Reference in the specification to “an example” or similar language means that a particular feature, structure, or characteristic described in connection with the example is included in at least one example, but not necessarily in other examples. The various instances of the phrase “in one example” or similar phrases in various places in the specification are not necessarily all referring to the same example.

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the scope of the disclosure. Thus, the present disclosure is not intended to be limited to the examples shown herein but is to be accorded the widest scope consistent with the principles and novel features disclosed herein.

What is claimed is:

1. A system comprising:
a display module; and
a computing device comprising:
a base member;
a display member rotatably connected to the base member, wherein the display module is attachable to edges of the base member and display member; and
a processor to:
determine which edge of the base member or display member the display module is to attach to;
determine an orientation of the display module with respect to the edge the display module is to attach to; and
adjust a display setting on the display module based on the orientation and the edge the display module is to attach to.

2. The system of claim 1, wherein the computing device comprises a distinct Hall effect sensor along each edge of the base member and display member.

3. The system of claim 2, wherein the processor to determine which edge the display module is to attach to comprises the processor to determine which of the distinct Hall effect sensor along each edge of the base member and display member is to activate.

4. The system of claim 1, wherein the processor to determine the orientation of the display module comprises the processor to:
read an analog-to-digital conversion (ADC) value generated when the display module is to attach to the edge;
determine the display module is in a portrait orientation if the ADC value is a first preset value; and
determine the display module is in a landscape orientation if the ADC value is a second preset value different from the first preset value.

5. The system of claim 4, wherein the processor is to:
determine a peripheral in place of the display module is attached to the edge if the ADC value is a third preset value different from the first and second preset values; and
determine an invalid module is attached to the edge if the ADC value generated does not equal the first, second, or third preset value.

6. The system of claim 4, wherein an edge of the display module attaching the display module in either the portrait or landscape orientation comprises a particular Hall Effect sensor that activates to indicate the display module is attached to the edge of the display member or base member in that detected orientation.

7. The system of claim 6, wherein the display module comprises instructions to change an orientation of viewable data received from the processor, according to the detected orientation of the display module.

8. The system of claim 1, wherein upon determining the edge of the base member or display member the display module is to attach to, the processor is to enable a port along the edge to power the display module and output viewable data to the display module.

9. The system of claim 8, wherein the viewable data is an extension of what is output on the display member of the computing device.

10. A non-transitory computer-readable storage medium comprising program instructions which, when executed by a processor, cause the processor to:
determine which edge of a computing device a display module is to attach to;
upon determining the edge of the computing device the display module is to attach to, enable a port along the edge to power the display module; and
output viewable data to the display module, wherein the viewable data is based on the edge the display module is to attach to.

11. The non-transitory computer-readable storage medium of claim 10, wherein the program instructions to cause the processor to determine which edge the display module is to attach to comprises program instructions to cause the processor to determine which Hall effect sensor along each edge of the computing device is to activate.

12. The non-transitory computer-readable storage medium of claim 10, comprising program instructions to cause the processor to;
determine an orientation of the display module with respect to the edge the display module is to attach to; and
adjust a display setting on the display module based on the orientation and the edge the display module is to attach to.

13. A method comprising:
determining which edge of a computing device a display module is to attach to;
upon determining the edge of the computing device the display module is to attach to, enabling a port along the edge to power the display module;
determining an orientation of the display module with respect to the edge the display module is to attach to; and
adjusting a display setting on the display module based on the orientation and the edge the display module is to attach to.

14. The method of claim 13, wherein the computing device comprises a distinct Hall effect sensor along each edge of the computing device.

15. The method of claim 14, wherein determining which edge the display module is to attach to comprises determining which of the distinct Hall effect sensor along each edge of the computing device is to activate.
